(19) United States
(12) Patent Application Publication
(10) Pub. No.: US 2018/0012437 A1
(43) Pub. Date: Jan. 11, 2018

(54) MULTIPART COIN BLANK AND COIN

(71) Applicants: Saxonia EuroCoin GmbH, Halsbruecke (DE); Bayerisches Hauptmuenzamt, Muenchen (DE); Crane Payment Innovations GmbH, Buxtehude (DE); Staatliche Muenzen Baden-Wuerttemberg, Stuttgart (DE)

(72) Inventors: Thomas Bilas, Freiberg (DE); Peter Huber, Heidenheim (DE); Konstantin Li, Dresden (DE); Klaus Meyer-Steffens, Deinste (DE); Stephan Siegel, Dresden (DE); Guenther Waadt, Muenchen (DE)

(21) Appl. No.: 15/712,943

(22) Filed: Sep. 22, 2017

Related U.S. Application Data
(63) Continuation of application No. 14/169,228, filed on Jan. 31, 2014.
Application No. 14/169,228 is a continuation of application No. PCT/EP2012/003239, filed on Jul. 30, 2012.

(51) Int. Cl. G07F 1/06; A44C 21/00

(52) U.S. Cl. CPC G07F 1/06; A44C 21/00

(57) ABSTRACT

A coin comprising a metallic disc separated from a concentric annular metallic ring by a concentric intervening layer. The metallic disc has a first electrical conductivity and the annular metallic ring has a second electrical conductivity. This intervening layer comprises a transparent dielectric material that connects the metallic disc to the annular metallic ring. The intervening layer has a width to provide a separation of inductive signatures of the metallic disc and the annular metallic ring. The width is based on an electrical conductivity ratio of the first electrical conductivity to the second electrical conductivity and is further based on a geometry of the coin. In some embodiments, the intervening layer comprises a transparent polymer including additives, such as a UV stabilizer or a fluorescent component.

### REFERENCE TO RELATED APPLICATION

This application is a continuation of U.S. application Ser. No. 14/169,228 filed on Jan. 31, 2014, and PCT/EP2012/003239 filed on Jul. 30, 2012, the contents of which are incorporated by reference in their entirety.

### BACKGROUND

The present application relates to a multipart coin blank that includes an inner portion and one or more outer portions surrounding the inner portion. The inner portion and the outer portions are connected to each other in a force-locked manner. The application further relates to a multipart coin.

### DESCRIPTION OF RELATED ART

Bimetallic coins have been increasingly brought into circulation as currency coins. The introduction of bimetallic coins eases identification of and distinction between coins having similar size, form and weight, but different face values. Bimetallic coins improve protection against accidental or intentional misuse of wrong coins. During the passage of a coin through a coin-operated machine, actual inductive and electromagnetic parameter values of the coin are compared with nominal parameter values of materials and material combinations used for coins having certain face values. For a bimetallic coin formed from a disc and a ring surrounding the disc, the inspection is performed for both materials, i.e. actual characteristic parameter values of both the ring and the disc are tapped and compared with nominal characteristic parameter values stored in the coin-operated machine. This allows for the reliable identification of coins according to a given face value and distinction from foreign coins and imitations.

It is an object of the invention to provide a coin blank increasing the reliability of identification of coins of different currencies and face values. The object is achieved with the subject matter of the independent claim. The dependent claims relate to more detailed embodiments.

### SUMMARY

A coin blank includes an inner portion and at least one outer portion surrounding the inner portion. An isolation layer between the inner portion and the outer portion connects the inner portion and the outer portion in a force-locking manner. The isolation layer is transparent in a first wavelength range and absorbs light in a second wavelength range.

The described embodiments, together with further advantages, will be best understood by reference to the following detailed description taken in conjunction with the accompanying drawings. The elements of the drawings are not necessarily to scale relative to each other.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings. Like reference numerals designate identical or corresponding parts throughout the several views.

FIG. 1A is a schematic plan view of a multipart coin blank according to an embodiment related to a bimetallic coin.

FIG. 1B is a schematic cross-sectional view of the bimetallic coin of FIG. 1A along line B-B.

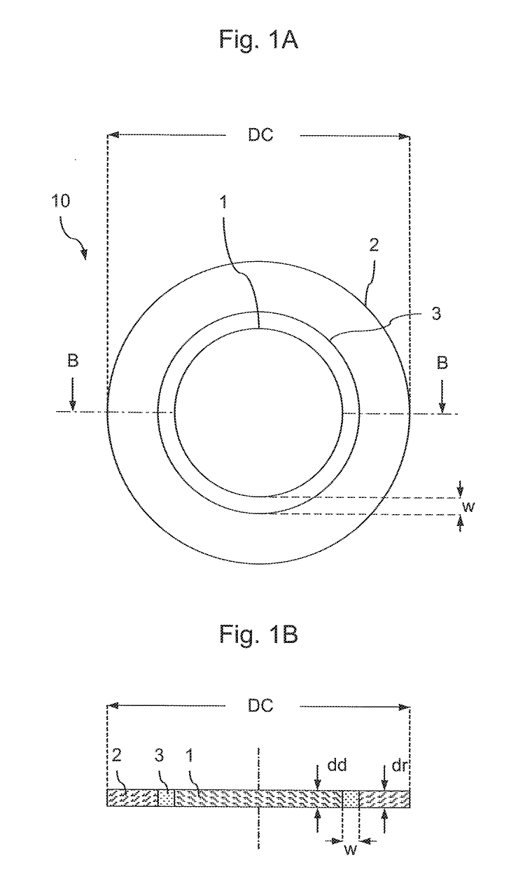

### DESCRIPTION OF THE EMBODIMENTS

The Figures show a coin blank 10 including an inner portion 1 and an outer portion 2 surrounding the inner portion 1. The inner portion 1 may be a disc which shape may be a regular circle, a circle with scallops, notches or flat portions, an oval, an ellipse, or a regular or irregular polygon with or without rounded corners. According to an embodiment, the inner portion may be a ring with a concentric opening. The inner surface of the outer portion 2 may be equidistant to the outer surface of the inner portion 1. Accordingly, the contour of the inner surface of the outer portion 2 oriented to the inner portion 1 may be a regular circle, a circle with scallops, notches or flat portions, an oval, an ellipse, or a regular or irregular polygon with or without rounded corners. The outer surface of the outer portion 2 may be equidistant to the inner surface and the shapes of the outer and inner surfaces may be the same. According to other embodiments, the outer surface of the outer portion 2 has another shape than the inner surface and the outer portion 2 may have a non-uniform width. For example, the inner surface may have a circular contour and the outer surface may be a polygon. The coin blank 10 may include one, two or more outer portions 2, wherein the innermost outer portion 2 surrounds the inner portion 1 and further outer portions 2 surround the respectively preceding outer portion 2.

According to the illustrated embodiment, the inner portion 1 is a disc which shape is a regular circle and the shape of the outer portion 2 is a concentric regular ring. Other embodiments may provide two, three or more concentric outer portions. The inner portion 1 and the outer portion 2 may be arranged in the same plane. A thickness dd of the inner portion 1 may be smaller, equal or greater than the thickness dr of the outer portion 2. According to an embodiment the distance between the disc-like inner portion 1 and the outer portion 2 may be uniform over the complete disc perimeter. The distance may be in the range of 0.1 to 5.0 mm. In accordance with an embodiment, the distance is in the range from 0.5 to 3.0 mm. According to the illustrated embodiment, the inner portion 1 and the inner diameter of the outer portion 2 are regularly circular and concentric and the distance between the inner portion 1 and the outer portion 2 is uniform over the whole perimeter of the inner portion 1.

The inner and outer portions 1, 2 may be pure metals, e.g. Cu, metal alloys and/or coated metals. Corpuses of the inner and outer portions 1, 2 may be massive (homogenous) or multi-layered stacks with cladded, coated or electroplated layers. According to an embodiment, at least one of the materials of the inner portion 1 and the outer portion 2 is a stainless steel, e.g. a ferritic steels, or a copper alloy, for example a copper alloy selected from a group including CuNi, CuAlNi, CuZnNi, CuSn, CuZn, CuAlZnSn.

An isolation layer 3 fills a gap between the inner portion 1 and the outer portion 2 in a permanently force-locking manner. The isolation layer 3 is provided from a dielectric insulating material.

Between disc and ring of a conventional bimetallic coin, electrochemically induced corrosion along the interface between ring and disc may result in a high variation of the contact resistances, wherein the effect of corrosion is the stronger the higher the potential differences are between the materials used for ring and disc. The wide contact resistance variations result in that wide parameter ranges must be accepted for a certain currency coin for automatic coin identification in coin-operated machines and coin validators. The spread distribution of measurement results may result in that bimetallic coins cannot be correctly identified, that imitations may erroneously be quoted as valid coins and that valid coins may erroneously be rejected as non-valid coins. Instead, the isolation layer 3 of the coin blank 10 reliably insulates the inner portion 1 and the outer portion 2 and hampers electrochemically induced corrosion. The inductive and electromagnetic parameter values of a coin based on the coin blank 10 are long-time stable and narrow nominal parameter ranges for a certain face value can be given for automatic coin identification.

The isolation layer 3 is formed from a transparent material. Conventional bimetallic coins may be mixed up optically with bimetallic coins having another face value or with foreign currency values because of too little differences in seize, engraving (stamping) and colour nuances. A transparent isolation layer 3 provides a further significant optical characteristic that increases the differences among multipart coins of different currencies and face values. The transparency of the isolation layer 3 supports a better visual differentiation at cash payment transactions, by way of example.

The isolation layer 3 may be based on a break-proof silicate or ceramic base material. According to an embodiment, the isolation layer 3 contains or consists of a polymer or a composite material, which is thermal stable at least in the conventional temperature range for coins. The material of the isolation layer 3 may be thermal stable even above 150 degree Celsius up to at least 200 degree Celsius. As regards regularly circular concentric disc-shaped inner portions 1 and ring-shaped outer portions 2, the width of the isolation layer 3 may be in the range from 0.5 to 3.0 mm to allow good optical perception of the isolation layer 3 during out-of-pocket payments and without the coin loosing the typical grip.

According to an embodiment, the isolation layer 3 is based on a polymer that contains sulphur, e.g. poly sulphone, or ether ketone, like polyether ether ketone (PEEK). Other embodiments may provide the isolation layer 3 from a composite material containing an organic base material that is doped with one or more inorganic materials. In accordance with an embodiment, the isolation layer 3 contains an organic base material and at least one type of pigments (dye), an ultraviolet (UV) stabilizer, fluorescent components and/or particles generating holographic effects.

According to another embodiment, the coin blank 10 may include an inner portion 1 and an outer portion 2 surrounding the inner portion 1. An isolation layer 3 is arranged between the inner portion 1 and the outer portion 2 and may connect the inner portion 1 and the outer portion 2 in a force-locking manner. The isolation layer 3 is to a high degree transparent in a first wavelength range, for example the visible wavelength range, and to a high degree opaque i.e. absorbant and/or reflective in a second wavelength range, for example the near infrared range.

The first wavelength range may be or may include wavelength ranges outside the visible wavelength range, for example portions of the UV and/or IR range next to the visible wavelength range. According to an embodiment the first wavelength range is a visible wavelength range, e.g. a portion of the visible wavelength range or the complete visible wavelength range. The second wavelength range may be or may include a visible wavelength range, e.g. a portion of the visible wavelength range or the complete visible wavelength range. According to an embodiment the second wavelength range may be or may include wavelength ranges outside the visible wavelength range, for example portions of the UV and/or IR range next to the visible wavelength range, e.g. NIR.

Typically, coin identification stages distinguish coins from other objects inserted in the coin slot of an apparatus like a coin-operating machine or coin validator. The coin identification stage may include a photo sensor sampling the size of an object passing the coin slot. Further on many apparatuses like coin operated machines and coin validators use photo sensors to detect the coin position during coin handling in the apparatus or to confirm that the coin leaves the exit of the apparatus. When a coin including the transparent isolation layer 3 passes a photo sensor evaluating the visible and other spectral ranges, e.g. the infrared including near infrared range, the coin identification stage may wrongly interpret the isolation layer 3 as a gap between two objects and hence may detect three objects instead of one bimetallic coin. With an isolation layer 3 being opaque in the near infrared range, a malfunction of the coin identification stage can be avoided if the photo sensor evaluates the near infrared range. The wavelength selective transparency of the isolation layer 3 allows for an automatic optic detection of such coins in coin validators and coin operated machines, which use a certain wavelength range, e.g. the near infrared range, for coin identification, without loosing the transparency in another wavelength range, e.g. the visual wavelength range.

The shape of the inner portion 1 may be a circle and the outer portion 2 may be a ring concentric with the inner portion 1. The second wavelength range may be a near infrared range including at least the wavelength range from 700 nm to 1100 nm. The first wavelength range may be a visible wavelength range including at least portions of the wavelength range from 400 to 700 nm. The transmittance in the visible wavelength range may vary from 50% to at least 90%. For example, the transmittance in the first wavelength range, e.g. the visible wavelength range, may be more than 90% or 95%. The absorptance (attenuation factor) in the second wavelength range, e.g. the near infrared range, may be at least 70% (0.7), for example at least 80%. (0.8) The isolation layer 3 may be based on a transparent polymer and may contain additives absorbing or reflecting light in a near infrared range by at least 80%. According to an embodiment, the additive may include particles of one or more metal oxides. The metal oxides may be selected from a group including zinc oxide and aluminium-doped zinc oxide. According to another embodiment, the additive may be a conducting polymer. The conducting polymer may be selected from a group including polythiopene and lanthanide bisphthalo cyanine. According to a further embodiment, the additive may be an organic compound containing metal complexes absorbing in the near infrared range. The metal complexes may be mixed-valence binuclear metal complexes. The weight component of the additives is at most 5% to maintain the transparent characteristic in the visible wavelength range.

The width w of the isolation layer 3 between the inner and the outer portions 1, 2 may be between 0.3 mm and 5 mm. According to an embodiment the width w is at least 0.50 mm to facilitate a safe detection of the isolation layer 3 in coin validators and coin operated machines providing photo sensors for coin detection. The width w may be at most 3.0 mm to ensure a reliable mechanical connection between the inner and outer portions 1, 2. According to other embodiments the width w of the isolation layer 3 is selected within a range from 0.5 mm to 3.0 mm by considering the characteristics of the inner and outer portions 1, 2.

For example, the width of the isolation layer 3 is selected on the basis of material properties of the inner and outer portions 1, 2. According to an embodiment, the electric conductivity CI of the inner portion 1 is at most half of the electric conductivity CO of the outer portion 2 and the width w of the isolation layer 3 is at least 0.5 mm because safe detection is possible even for smaller widths. According to another embodiment, the electric conductivity CI of the inner portion 1 is at least twice the electric conductivity CO of the outer portion 2 and the width of the isolation layer 3 is at least 1.0 mm to facilitate safe detection of the isolation layer 3 If the electric conductivities CI, CO of the inner and outer portions 1, 2 deviate from each other by no more than 50% and the IACS (international annealed copper standard) value is below 10%, the width w of the isolation layer 3 is at least 1.0 mm. If the electric conductivities CI, CO of the inner and outer portions 1, 2 deviate from each other by no more than 50% and the IACS (international annealed copper standard) value is 10% or more, the width w of the isolation layer 3 is at least 0.5 mm.

According to another embodiment, the width w of the isolation layer 3 is selected on the basis of the coin geometry to support a safe identification of coin type and face value. Usually coin operated machines and coin validators use inductive sensors for identifying the materials of the coin. Inner and outer portions 1, 2 deliver a respective inductive signature and the isolation layer 3 provides a certain separation of the signatures. A sufficient separation eases the evaluation and identification of the signatures. For achieving a sufficient separation, the width w of the isolation layer 3 is selected considering the diameter DC of the coin blank and the diameter of the inner portion 1. According to an embodiment referring to coin diameters DC from 19 mm to 33 mm and a ratio of the diameter of the inner portion 1 to the coin diameter DC between 50% and 70%, e.g. approximately 60%, the width w may be selected according to equation (1).

(DC−19mm)·0.1+0.5 mm≦w≦(DC−19mm)·0.2+0.5mm (1)

For example, at a coin diameter DC of 20 mm the width w of the isolation layer 3 may be in the range from 0.6 mm to 0.7 mm. At a coin diameter DC of 30 mm, the width w of the isolation layer 3 may be in the range from 1.6 mm to 2.7 mm. According to the same embodiment, for coin diameters DC below 19 mm the width w of the isolation layer 3 is at least 0.5 mm.

According to a further embodiment, the coin blank includes at least one further outer portion 2 separated by the preceding outer portion 2 by a further isolation layer 3 having the characteristics of the isolation layer 3 between the inner portion 1 and the outer portion 2.

A further embodiment relates to a coin which may be a currency coin or a medal. The coin includes the coin blank as discussed above and a stamping stamped on at least one side of at least one of the inner and outer portions 1,2.

The following embodiments refer to coins or coin blanks including an inner portion 1, at least one outer portion 2 surrounding the inner portion 1, and a dielectric isolation layer 3 between the inner portion 1 and the outer portion 2 and connecting the inner portion 1 and the outer portion 2 in a force-locking manner, wherein a width w of the isolation layer 3 is selected on the basis of properties, e.g. material properties and geometry, of the inner and outer portions 1, 2. The isolation layer 3 may be transparent in at least portions of the visible wavelength range, in the complete visible wavelength range and/or in wavelength ranges next to the visible wavelength range, e.g. in the UV range and/or in at least a portion of the IR range, e.g. in the NIR.

According to such an embodiment, the electric conductivity CI of the inner portion 1 is at least twice the electric conductivity CO of the outer portion 2 and the width w of the isolation layer 3 is at least 1.0 mm to facilitate safe detection of the isolation layer 3. According to another embodiment the electric conductivity CI of the inner portion 1 is at most half of the electric conductivity CO of the outer portion 2 and the width wof the isolation layer 3 is at least 0.5 mm, because safe detection is possible even for smaller widths. According to another embodiment, if the electric conductivities CI, CO of the inner and outer portions 1, 2 deviate from each other by no more than 50% and the IACS (international annealed copper standard) value is below 10%, the width w of the isolation layer 3 is at least 1.0 mm. If the electric conductivities of the inner and outer portions 1, 2 deviate from each other by no more than 50% and the IACS (international annealed copper standard) value is 10% or more, the width w of the isolation layer 3 is at least 0.5 mm.

According to another embodiment, the width w of the isolation layer 3 is selected on the basis of the coin geometry to support a safe identification of coin type and face value. Usually coin operated machines and coin validators use inductive sensors for identifying the materials of the coin. Inner and outer portions 1, 2 deliver a respective inductive signature and the isolation layer 3 provides a certain separation of the signatures. A sufficient separation eases the evaluation and identification of the signatures. For achieving a sufficient separation, the width w of the isolation layer 3 is selected considering the diameter DC of the coin and the diameter of the inner portion 1. According to an embodiment referring to coin diameters DC from 19 mm to 33 mm and a ratio of the diameter of the inner portion 1 to the coin diameter DC between 50% and 70%, e.g. approximately 60%, the width w may be selected according to equation (1) above.

For example, at a coin diameter DC of 20 mm the width w of the isolation layer 3 may be in the range from 0.6 mm to 0.7 mm. At a coin diameter DC of 30 mm, the width w of the isolation layer 3 may be in the range from 1.6 mm to 2.7 mm. According to the same embodiment, for coin diameters DC below 19 mm the width w of the isolation layer 3 is at least 0.5 mm.

A further example is a bimetallic coin including an inner portion 1 consisting of a cladded three layers nickel-brass-alloy/nickel/nickel-brass-alloy corpus and a ring-shaped outer portion 2 consisting of CuNi25. The diameter of the inner portion 1 is smaller than the inner diameter of the outer portion 2 by 1.5 mm. An isolation layer 3 provided from an amorphous and transparent polymer, e.g. polysulphone, fills the resulting gap in a force-locking manner.

Another example is a bimetallic coin that includes a ring-shaped outer portion 2 consisting of stainless steel, a disc consisting of a CuAlZn alloy, and an isolation layer 3 having a width of 0.5 mm. The isolation layer 3 consists of a semicrystalline polymer. According to an embodiment, the isolation layer 3 consists of polyether ether ketone (PEEK), which colour is light brown and which is not transparent, i.e. opaque.

According to another example the isolation layer 3 is a composite material consisting of the transparent polymer polysulphone doped with 3% in weight with fluorescent fibres providing striking lighting effects under UV light, which are usable as a further identification characteristic.

According to a more general example, a bimetallic coin consists of a disc-shaped inner portion and a concentric, annular-shaped outer portion, which form a permanently connected composite on which a face value provided for the coin is stamped. An isolation layer is concentrically arranged between the inner portion and the outer portion in a force-locking manner.

According to an embodiment of the more general example, the isolation layer consists of a polymer or a composite material. The polymer may be a polymer containing sulphur or an etherketone-containing polymer. For example, a polysulphone (PSU) or a polyether etherketone (PEEK) is used. The composite material may consist of an organic base material which is doped with an inorganic material. Pigments, UV-stabilizers, fluorescent components and/or particles with holographic imaging may be used as inorganic material. The composite material may consist of amorphous silicate or ceramic base materials.

According to another embodiment of the more general example, the isolation layer withstands temperatures above 150 degree Celsius.

According to another embodiment of the more general example, the isolation layer has transparent, semi-transparent (translucent), opalescent characteristics and/or includes colour effects.

According to another embodiment of the more general example, the width of the isolation layer between the disc and the ring ranges from 0.5 mm to 3.0 mm.

According to another embodiment of the more general example, the isolation layer is deformable by a stamping process applied to provide a currency coin from the coin blank.

Obviously, numerous modifications and variations of the present disclosure are possible in light of the above teachings. It is therefore to be understood that within the scope of the appended claims, the invention may be practiced otherwise than as specifically described herein.

1. A coin blank comprising
an inner portion having a first electrical conductivity,
an outer portion annularly surrounding the inner portion, the outer portion having a second electrical conductivity, and
a dielectric isolation layer between the inner and the outer portion, wherein the dielectric isolation layer connects the inner portion and the outer portion, the dielectric isolation layer having a width selected to provide a separation of inductive signatures of the inner portion and the outer portion, the width being based on an electrical conductivity ratio of the first electrical conductivity to the second electrical conductivity and being further based on a geometry of the coin.

2. The coin blank according to claim 1, wherein the width of the dielectric isolation layer ranges from 1.0 mm to 3.0 mm.

3. The coin blank according to claim 2, wherein a diameter of the coin blank ranges from 19 to 33 mm.

4. The coin blank according to claim 1, wherein the dielectric isolation layer connects the inner portion and the outer portion in a form-fitting manner.

5. The coin blank according to claim 1, wherein the outer portion is a ring.

6. The coin blank according to claim 1, wherein the dielectric isolation layer is comprised of a transparent polymer including additives.

7. The coin blank according to claim 6, wherein the additives comprise a fluorescent component.

8. The coin blank according to claim 6, wherein the additives comprise fluorescent fibers providing striking lighting effects under UV light.

9. The coin blank according to claim 6, wherein the additives comprise a UV stabilizer.

10. The coin blank according to claim 6, wherein the additives cause the dielectric isolation layer to be transparent in a visible wavelength range and opaque in at least a portion of a near infrared range.

11. A coin blank comprising
an inner portion,
an outer portion annularly surrounding the inner portion, and
a dielectric isolation layer between the inner and the outer portion, wherein the dielectric isolation layer connects the inner portion and the outer portion, the dielectric isolation layer having a planar surface.

12. The coin blank according to claim 11, wherein
the inner portion has a first electrical conductivity, and
the outer portion has a second electrical conductivity,
wherein the first electrical conductivity deviates from the second electrical conductivity.

13. The coin blank according to claim 11, wherein the dielectric isolation layer is comprised of a transparent polymer that contains up to 5% of additives by weight so that the dielectric isolation layer is transparent in a visible wavelength range and to a high degree opaque in a portion of a near infrared range.

14. A coin blank comprising
an inner portion,
an outer portion annularly surrounding the inner portion, and
a dielectric isolation layer between the inner and the outer portion, wherein the dielectric isolation layer connects the inner portion and the outer portion and the dielectric isolation layer is comprised of a transparent polymer and additives including a UV stabilizer or a fluorescent component.

15. The coin blank according to claim 14, wherein the fluorescent component comprises fluorescent fibers providing striking lighting effects under UV light.

16. The coin blank according to claim 14, wherein the dielectric isolation layer has a width of 1.0 to 3.0 mm and the coin blank has a diameter of 19 to 33 mm.

17. The coin blank according to claim 14, wherein the additives cause the dielectric isolation layer to be transparent in a visible wavelength range and opaque in at least a portion of a near infrared range.

18. The coin blank according to claim 14, wherein the transparent polymer is a conducting polymer, and wherein the additives include particles of one or more metal oxides.

19. The coin blank according to claim 18, wherein the transparent polymer comprises at least one of polythiopene or lanthanide bisphthalo cyanine is zinc oxide, and additives comprise at least one of zinc oxide or aluminium-doped zinc oxide.

20. The coin blank according to claim 14, wherein the inner portion has a first electrical conductivity and the outer portion has a second electrical conductivity, and a width of the dielectric isolation layer is selected to provide a separation of inductive signatures of the inner portion and the outer portion, the width being based on an electrical conductivity ratio of the first electrical conductivity to the second electrical conductivity and being further based on a geometry of the coin.
